(19) United States
(12) Patent Application Publication
(10) Pub. No.: US 2012/0192831 A1
(43) Pub. Date: Aug. 2, 2012

(54) Combustion Chamber for a Side-Mounted Direction Injector

(75) Inventor: Adrian Tusinean, Windsor (CA)

(73) Assignee: EcoMotors International, Inc., Dearborn, MI (US)

(21) Appl. No.: 13/351,863

(22) Filed: Jan. 17, 2012

Related U.S. Application Data
(60) Provisional application No. 61/436,877, filed on Jan. 27, 2011.

(51) Int. Cl. F02M 69/04

(52) U.S. Cl. 123/299

(57) ABSTRACT

In an opposed-piston, opposed-cylinder engine, a high degree of swirl is developed during the scavenging process and persists into the combustion stroke. The engine has one or more injectors at the periphery of the combustion chamber injecting fuel into the air at the point in which the air has the highest tangential velocity. The swirling air causes the jets to be pushed together and some of the jets to be pushed into the cylinder wall. According to an embodiment of the disclosure, the exhaust piston has a raised portion and a recessed portion. Protuberances extending inwardly are provided on the raised portion of the exhaust piston to dampen the swirl.

### CROSS REFERENCE TO RELATED APPLICATIONS

The present application claims priority benefit from U.S. provisional patent application 61/436,877 filed 27 Jan. 2011.

### FIELD

The present disclosure relates to a combustion chamber configuration suitable when the injector is side mounted with respect to the combustion chamber.

### BACKGROUND

Opposed-piston, opposed-cylinder engines have a combustion chamber delimited by a cylinder wall, an intake piston, and an exhaust piston. A fuel injector, or a pair of fuel injectors, is disposed in the cylinder wall. Typically, fuel injectors in compression-ignition (diesel) engines are centrally mounted. With central injection air into which the fuel is injected into is relatively quiescent even when there is substantial swirl. The fuel jets, as they penetrate further into the combustion chamber, are more affected by the swirling air. However, by the time the fuel jets have penetrated into the swirling air, much of the fuel has already been dispersed and the jets are well separated. With fuel injectors mounted in the cylinder walls, in contrast, the tips of the fuel jets, as they leave the injector, are acted upon by the air with the highest tangential velocity in the cylinder. An example is shown in FIG. 1 in which the swirl number is 2 and the bore diameter is 100 mm at three engine speeds: 1000, 2000, and 4000 rpm. The tangential velocity at the center of the cylinder is zero and 10.5, 21, and 42 m/s at the periphery of the cylinder respectively. Referring now to FIG. 2, a problem with a high tangential velocity is that fuel jets 2a, 2b, 2c, and 2d emanating from injector 4 are displaced toward a wall 6 of the cylinder. The air utilization is poor, as can be partially explained by the portion of the cylinder 8 in which there is no fuel jet. The illustration in FIG. 2 indicates the envelope of the dense part of the jets. It is not shown, by such a representation, that the outer edges of the spray are overlapping, which may be detrimental to air entrainment.

One way to overcome this is to design the intake system such that it produces minimal swirl in the chamber. However, in the opposed-piston, opposed-cylinder engine, the air is inducted through ports in the cylinder walls that are uncovered by the intake piston. To facilitate scavenging, which is critical to achieving high power from such a two-stroke configuration, the flow into the cylinder is relatively aggressive and promotes swirl. Minimizing swirl would negatively impact scavenging and thus reduce engine power. The two goals are largely at cross purposes.

Another option is to cause the jets to be directed slightly into the swirl so that after the jets are displaced by the swirl, they attain the desired distribution in the cylinder. It may be possible to find an orientation of the jets that provides the desired distribution at one engine speed, i.e., one swirl condition, but not at the range of engine speeds encountered in an internal combustion engine. Because the tangential velocity is roughly linear with engine speed and the ratio of minimum to maximum engine speed is typically about eight fold, the resulting tangential velocity varies about eight fold.

### SUMMARY

To at least partially overcome challenges presented by an injector mounted peripherally in a cylinder wall, one embodiment of a combustion chamber is disclosed that is defined by a cylinder liner, an intake piston adapted to reciprocate within the cylinder liner, a first injector disposed in the cylinder liner with a tip of the first injector directed generally toward a center of the cylinder liner, a second injector disposed in the cylinder liner with a tip of the second injector directed generally toward a center of the cylinder liner, and an exhaust piston adapted to reciprocate within the cylinder liner. The piston top of the exhaust piston has a recessed portion and a raised portion with a majority of the recessed portion generally centrally located on the piston top. The recessed portion also has a first channel connecting a periphery of the piston with the majority of the recessed portion and a second channel connecting the periphery of the piston with the majority of the recessed portion. The raised portion has two protuberances that extend inwardly into the recessed portion with a line connecting the two protuberances substantially perpendicular to a line connecting the tips of the first and second injectors. The first injector is indexed with the first channel so that fuel injected from the first injector travels to the recessed portion through the first channel and the second injector is indexed with the second channel so that fuel injected from the second injector travels to the recessed portion through the second channel. The top of the exhaust piston and a top of the intake piston face each other. The top of the intake piston is generally a concave portion of a sphere of a predetermined diameter; the raised portion of the exhaust piston is generally a convex portion of a sphere of the predetermined diameter and substantially all of the raised portion of the exhaust piston is displaced from the top of the intake piston by the same distance as measured parallel to a central axis of the cylinder liner. The recessed portion also has a ridge running roughly between the two protuberances of the raised portion. A top of the intake piston is generally a concave portion of a sphere with channels defined in the piston top; and the channels are indexed with the first and second injectors.

In another embodiment, a combustion chamber system include a combustion chamber delimited by a cylinder wall and a piston top of a piston within the cylinder wall wherein the piston top has a raised portion located predominantly proximate the cylinder wall. The piston top has a recessed portion predominantly located inside the raised portion. The recessed portion has at least one channel extending outwardly to the periphery of the piston. At least a portion of the recessed portion roughly forms a fan shape with a base of the fan shape coincident with the channel. The system further includes a fuel injector mounted in the cylinder wall with a tip of the fuel injector at a substantially identical radial position as the channel of the piston top so that fuel emanating from the fuel injector travels through the channel into the fan shaped portion. In some embodiments, the piston is an exhaust piston and the combustion chamber is further delimited by an intake piston within the cylinder wall. A piston top of the intake piston roughly comprises a portion of a concave sphere of a predetermined diameter. The raised portion of the exhaust piston roughly comprises a portion of a convex sphere of the predetermined diameter and the spherical portions of the piston tops index with each other such that the piston top of the intake piston and the raised portion of the exhaust piston have a constant separation distance at all points with respect to the raised portion of the exhaust piston.

In some embodiments, the piston top has first and second channels extending outwardly to the periphery of the piston. The combustion system further includes a first fuel injector mounted in the cylinder wall with a tip of the first fuel injector at a substantially identical radial position as the first channel of the piston top so that fuel emanating from the first fuel injector travels through the first channel into the recessed portion and a second fuel injector mounted in the cylinder wall with a tip of the second fuel injector at a substantially identical radial position as the second channel of the piston top so that fuel emanating from the second fuel injector travels through the second channel into the recessed portion. In some embodiments, the first and second channels are substantially diametrically opposed.

The recessed portion is substantially shaped as first and second fans with a base of the first fan coincident with the first channel. A base of the second fan is coincident with the second channel. A center tip of the first and second fans approximately located along a central axis of the cylinder wall. In some embodiments, the recessed portion has a ridge arranged approximately equidistant from the two injectors. The raised portion has first and second protuberances extending inwardly into the recessed portion and the most inwardly directed portions of the protuberances lie along a line roughly perpendicular to a line connecting tips of the first and second injectors. The raised portion is a convex portion of a sphere.

Also disclosed in an internal combustion engine having a cylinder wall, an intake piston adapted to reciprocate in the cylinder wall, and an exhaust piston adapted to reciprocate in the cylinder wall with a piston top of the exhaust piston facing a piston top of the intake piston. The piston top of the exhaust piston has a raised portion and a recessed portion and the recessed portion forms at least one fan-shaped portion. The engine further includes at least one fuel injector mounted through the cylinder wall with a tip of the fuel injector proximate a gap between the tops of the intake and exhaust pistons when the intake and exhaust pistons are at their closest position. In one embodiment, the engine has two injectors, first and second injectors, that are mounted through the cylinder wall approximately diametrically opposed and the recessed portion forms first and second fan-shaped portions with a base of the first fan-shaped portion indexed with the first injector and a base of the second fan-shaped portion indexed with the second injector. The fan-shaped portion(s) has a base that extends to a periphery of the piston and a tip of the fan-shaped portion(s) extending away from the base is substantially centrally located on the piston. The raised portion has two protuberances extending inwardly toward the center of the piston. A line connecting the two protuberances is substantially perpendicular to a line connecting tips of the first and second injectors.

### BRIEF DESCRIPTION OF THE DRAWINGS

FIG. 1 shows the velocity profile in the cylinder due to swirl;

FIG. 2 shows an illustration of fuel jets emanating from a wall-mounted injector into a swirling flow based on shadowgraph images;

FIG. 3 is a top view of an exhaust piston crown in an embodiment with one side injector;

FIG. 4 is a cross-sectional view of the exhaust piston crown of FIG. 3 and an intake piston crown;

FIG. 5 is top view of an intake piston crown;

FIG. 6 is a top view of an exhaust piston crown in an embodiment with two side injectors;

FIG. 7 is a cross-sectional view of the exhaust piston crown of FIG. 6 and an intake piston crown; and

FIG. 8 is a representation of an opposed-piston, opposed-cylinder engine.

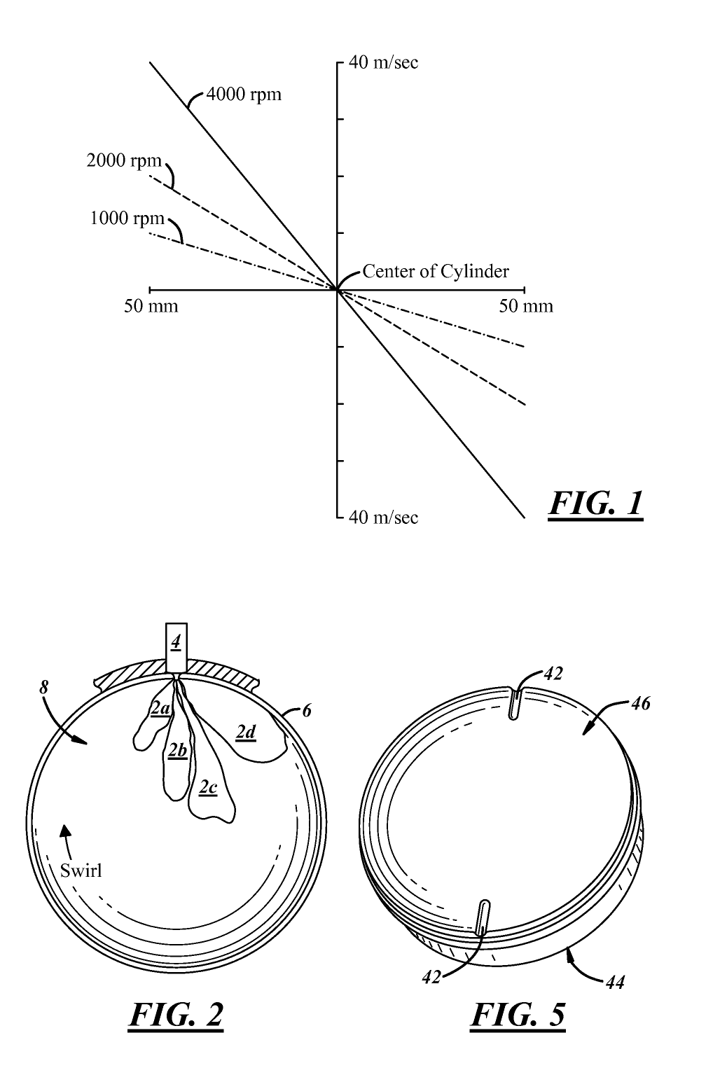

### DETAILED DESCRIPTION

As those of ordinary skill in the art will understand, various features of the embodiments illustrated and described with reference to any one of the Figures may be combined with features illustrated in one or more other Figures to produce alternative embodiments that are not explicitly illustrated or described. The combinations of features illustrated provide representative embodiments for typical applications. However, various combinations and modifications of the features consistent with the teachings of the present disclosure may be desired for particular applications or implementations. Those of ordinary skill in the art may recognize similar applications or implementations consistent with the present disclosure, e.g., ones in which components are arranged in a slightly different order than shown in the embodiments in the Figures. Those of ordinary skill in the art will recognize that the teachings of the present disclosure may be applied to other applications or implementations.

To promote distribution of the fuel in the combustion chamber from one or more side mounted fuel injectors, a combustion chamber is provided that at least partially disturbs swirl flow that persists from the intake process.

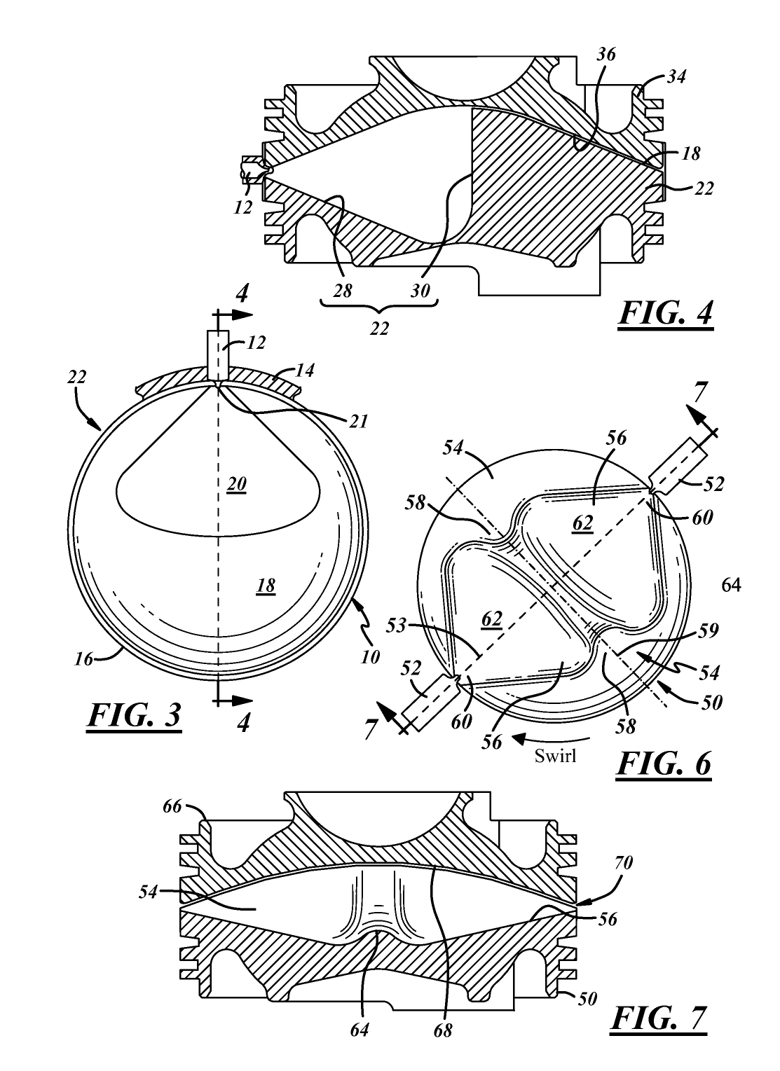

In FIG. 3, a piston top 10 of an exhaust piston is shown. An injector 12 is mounted through a cylinder liner 14, a portion of which is shown in FIG. 3. The piston has a slight chamfer around the periphery of the piston. The surface of piston top 10, i.e., other than the chamfer, is either a raised portion or a recessed portion 20. Recessed portion 20 is sometimes called a piston bowl, but is not referred to such in the present disclosure as the shape of recessed portion 20 is less of a classic bowl shape than in other combustion chambers. Recessed portion 20 has the shape of a fan as viewed from the top. Piston top 10 has a small channel 21 leading from the periphery of the piston into recessed portion 20. Piston top 10 is all that can be viewed of the piston crown 22 in FIG. 3, i.e., the ring groove and land portion and skirt portion are not visible. In some embodiments, the piston has two pieces: a crown and a skirt, which are bolted together or otherwise coupled.

In FIG. 4, a cross-sectional side view of piston crown 22 is shown. Raised portion 18 is substantially a portion of a sphere the surface of raised portion being convex. The recessed portion 22 has a portion 28 that slopes downward as well as a wall portion 30. Vertical wall portion 30 is just one example. Alternatively, the wall portion may angle backwards toward injector 12 or angle away from injector 12. Also shown in FIG. 4 is a piston crown for an intake piston 34. Piston crowns 22 and 34 are opposed pistons and are shown in their closest position during reciprocation within the cylinder wall (cylinder wall not shown in FIG. 4). The piston top of intake piston 36 is substantially a concave sphere of the same diameter as the sphere of surface 18 so that the gap between the two is nearly constant between raised surface 18 and piston top 36.

In FIG. 5, an isometric view of an intake piston crown 44 is shown. Piston top 46 has channels 42 to accommodate the fuel jets from two diametrically-opposed fuel injectors (injectors not shown) to obtain access to the combustion chamber without hitting the piston top.

In FIG. 6, an exhaust piston crown 50 is shown which accommodates fuel sprays from two injectors 52. Tips of the injectors are arranged on a dashed diametral line 53 across piston crown 50. Piston crown has a raised portion 54 and recessed portion 56. Raised portions 54 have protuberances 58 which extend inwardly, with protuberances 58 roughly centered along a dash-dot diametral line 59 that is approximately perpendicular to diametral line 53. In the embodiment in FIG. 6, recessed portion 56 has channels 60 leading from the periphery of the piston into fan-shaped portions 62. There is a ridge 64 between fan-shaped portions 62. Protuberances 58 and ridge 64 disrupt the swirl flow. In other alternatives, ridge 64 is not included to avoid the possibility of it becoming a hot spot. Another advantage of providing protuberances 58 is to decrease the volume in the combustion chamber (volume between the piston tops) at their closest position to facilitate a high compression ratio in embodiments calling for a high compression ratio.

Fan shaped portions 62, in FIG. 6, are asymmetrical with respect to line 53. They are twisted about 5 degrees in the direction of the swirl. Although piston crown 50 is designed to disrupt the swirl, swirl does still persist and fan shaped portions 62 are offset to align the combustion chamber with the fuel jets. The 5-degree offset is a compromise value between what is best at the lowest and highest engine speeds. In alternative embodiments, no offset is provided. In yet other embodiments, the amount of offset is greater or less than 5 degrees depending on the specifics of the engine design, intake design, etc.

In FIG. 7, piston crown 50 is shown in cross section with an intake piston crown 66 also in cross section. A top 68 of piston crown 66 may be a portion of a concave sphere and raised surface 54 a portion of a convex sphere. In one embodiment, the point of greatest recess of the concave sphere of top 68 is coincident with the longitudinal axis of the cylinder (not shown) in which the piston reciprocates. Alternatively, the concave sphere is offset; in yet another alternative, top 68 of piston crown 66 has a more complicated shape. Whether surfaces 68 and 54 are portions of spheres or not, they may be designed such that they index together forming a gap 70 of a particular height across raised surface 54.

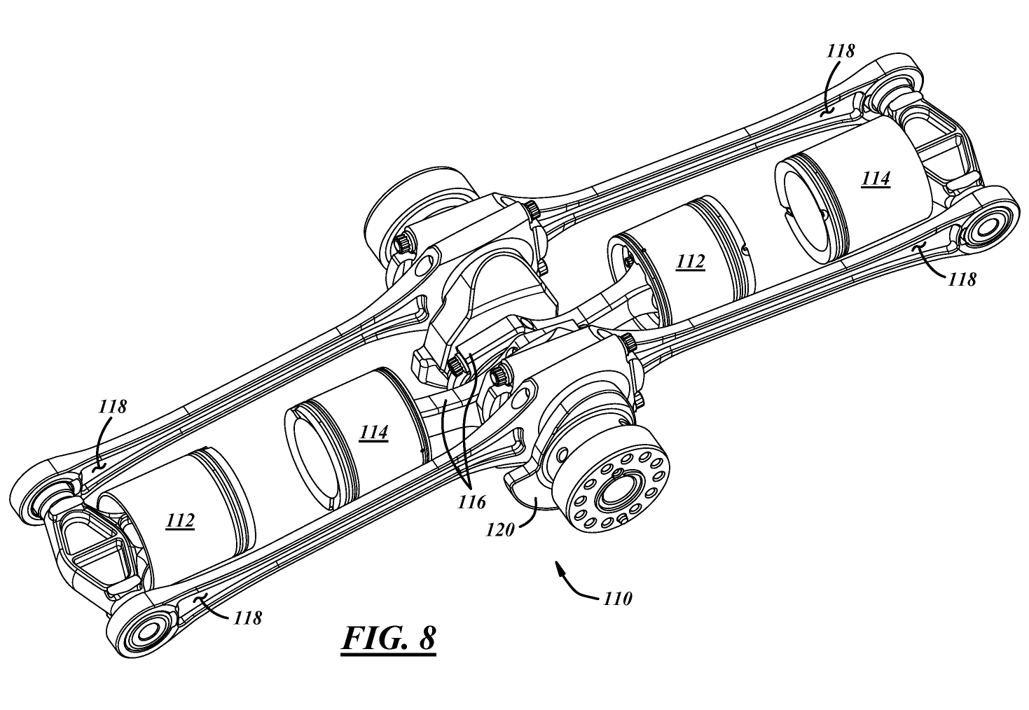

In FIG. 8, one embodiment of an opposed-piston, opposed-cylinder (OPOC) engine 110 is shown isometrically. An intake piston 112 and an exhaust piston 114 reciprocate within each of first and second cylinders (cylinders not shown to facilitate viewing pistons). One exhaust piston 114 couples to a journal (not visible) of crankshaft 120 via a pushrod 116 and the other intake piston 114 coupled to the journal via two pullrods 118. Similarly one of the intake pistons couples via a pushrod 116 and one couples via two pullrods 118.

While the best mode has been described in detail, those familiar with the art will recognize various alternative designs and embodiments within the scope of the following claims. Where one or more embodiments have been described as providing advantages or being preferred over other embodiments and/or over prior art in regard to one or more desired characteristics, one of ordinary skill in the art will recognize that compromises may be made among various features to achieve desired system attributes, which may depend on the specific application or implementation. These attributes include, but are not limited to: cost, strength, durability, life cycle cost, marketability, appearance, packaging, size, serviceability, weight, manufacturability, ease of assembly, etc. The embodiments described as being less desirable relative to other embodiments with respect to one or more characteristics are not outside the scope of the disclosure as claimed.

I claim:

1. A combustion chamber, comprising:
a cylinder liner;
an intake piston adapted to reciprocate within the cylinder liner;
a first injector disposed in the cylinder liner with a tip of the first injector directed generally toward a center of the cylinder liner;
a second injector disposed in the cylinder liner with a tip of the second injector directed generally toward a center of the cylinder liner; and
an exhaust piston adapted to reciprocate within the cylinder liner; a piston top of the exhaust piston having a recessed portion and a raised portion; a majority of the recessed portion is generally centrally located on the piston top; the recessed portion also has a first channel connecting a periphery of the piston with the majority of the recessed portion and a second channel connecting the periphery of the piston with the majority of the recessed portion; and the raised portion having two protuberances that extend inwardly into the recessed portion with a line connecting the two protuberances being substantially perpendicular to a line connecting the tips of the first and second injectors.

2. The combustion chamber of claim 1 wherein the first injector is indexed with the first channel so that fuel injected from the first injector travels to the recessed portion through the first channel and the second injector is indexed with the second channel so that fuel injected from the second injector travels to the recessed portion through the second channel.

3. The combustion chamber of claim 1 wherein the top of the exhaust piston and a top of the intake piston face each other; the top of the intake piston is generally a concave portion of a sphere of a predetermined diameter; the raised portion of the exhaust piston is generally a convex portion of a sphere of the predetermined diameter; and substantially all of the raised portion of the exhaust piston is displaced from the top of the intake piston by the same distance as measured parallel to a central axis of the cylinder liner.

4. The combustion chamber of claim 1 wherein the recessed portion also has a ridge running roughly between the two protuberances of the raised portion.

5. The combustion chamber of claim 1 wherein a top of the intake piston is generally a concave portion of a sphere with channels defined in the piston top; and the channels are indexed with the first and second injectors.

6. A combustion chamber system of an internal combustion engine, the combustion chamber system comprising a combustion chamber delimited by:
a cylinder wall; and
a piston top of a piston within the cylinder wall wherein the piston top has a raised portion located predominantly proximate the cylinder wall; the piston top has a recessed portion predominantly located inside the raised portion; the recessed portion has at least one channel extending outwardly to the periphery of the piston; and at least part of the recessed portion roughly forms a fan shape with a base of the fan shape coincident with the channel.

7. The combustion chamber system of claim 6, further comprising: a fuel injector mounted in the cylinder wall with a tip of the fuel injector at a substantially identical radial position as the channel of the piston top so that fuel emanating from the fuel injector travels through the channel into the recessed portion.

8. The combustion chamber system of claim 6 wherein the piston is an exhaust piston and the combustion chamber is further delimited by an intake piston within the cylinder wall.

9. The combustion chamber of claim 8 wherein a piston top of the intake piston roughly comprises a portion of a concave sphere of a predetermined diameter; the raised portion of the exhaust piston roughly comprises a portion of a convex sphere of the predetermined diameter; and the spherical portions of the piston tops index with each other such that the piston top of the intake piston and the raised portion of the exhaust piston have a constant separation distance at all points with respect to the raised portion of the exhaust piston.

10. The combustion chamber system of claim 6 wherein the piston top has first and second channels extending outwardly to the periphery of the piston, the system further comprising:
a first fuel injector mounted in the cylinder wall with a tip of the first fuel injector at a substantially identical radial position as the first channel of the piston top so that fuel emanating from the first fuel injector travels through the first channel into the recessed portion; and
a second fuel injector mounted in the cylinder wall with a tip of the second fuel injector at a substantially identical radial position as the second channel of the piston top so that fuel emanating from the second fuel injector travels through the second channel into the recessed portion.

11. The combustion chamber system of claim 10 wherein the first and second channels are substantially diametrically opposed.

12. The combustion chamber system of claim 10 wherein the recessed portion is substantially shaped as first and second fans with: a base of the first fan coincident with the first channel, a base of the second fan coincident with the second channel, and a center tip of the first and second fans approximately located along a central axis of the cylinder wall.

13. The combustion chamber system of claim 10 wherein the fan shape is a first fan shape and the channel is a first channel; the recessed portion of the piston top also comprises a second fan shape with a base of the second fan coincident with the second channel; and the tips of the first and second fans overlap at a location proximate a center of the piston.

14. The combustion chamber system of claim 13 wherein the recessed portion has a ridge arranged approximately equidistant from the two injectors.

15. The combustion chamber system of claim 10 wherein the raised portion has first and second protuberances extending inwardly into the recessed portion and the most inwardly directed portions of the protuberances lie along a line roughly perpendicular to a line connecting tips of the first and second injectors.

16. The combustion chamber system of claim 6 wherein the raised portion is a portion of a convex sphere.

17. An internal combustion engine, comprising:
a cylinder wall;
an intake piston adapted to reciprocate in the cylinder wall;
an exhaust piston adapted to reciprocate in the cylinder wall, with a piston top of the exhaust piston facing a piston top of the intake piston wherein the piston top of the exhaust piston has a raised portion and a recessed portion and the recessed portion forms at least one fan-shaped portion; and
at least one fuel injector mounted through the cylinder wall with a tip of the fuel injector proximate a gap between the tops of the intake and exhaust pistons when the intake and exhaust pistons are at their closest position.

18. The engine of claim 17 wherein the engine has two injectors, first and second injectors, that are mounted through the cylinder wall approximately diametrically opposed; and the recessed portion forms first and second fan-shaped portions with a base of the first fan-shaped portion indexed with the first injector and a base of the second fan-shaped portion indexed with the second injector.

19. The engine of claim 17 wherein the at least one fan-shaped portion has a base that extends to a periphery of the piston and a tip of the fan-shaped portion that extends away from the base is substantially centrally located on the piston.

20. The engine of claim 18 wherein the raised portion has two protuberances extending inwardly toward the center of the piston and a line connecting the two protuberances is substantially perpendicular to a line connecting tips of the first and second injectors.
